(19) United States
(12) Patent Application Publication
(10) Pub. No.: US 2016/0046378 A1
(43) Pub. Date: Feb. 18, 2016

(54) RESTRAINT FOR SIDE FACING SEATS INSTALLED IN AN AIRCRAFT

(71) Applicant: Sikorsky Aircraft Corporation, Stratford, CT (US)

(72) Inventor: Michael David Brandt, Suamico, WI (US)

(21) Appl. No.: 14/825,821

(22) Filed: Aug. 13, 2015

Related U.S. Application Data
(60) Provisional application No. 62/037,657, filed on Aug. 15, 2014.

(51) Int. Cl. B64D 11/06

(52) U.S. Cl. CPC B64D 11/062

(57) ABSTRACT

A personal restraint system configured for use with a seat oriented perpendicular to a direction of flight of an aircraft is provided including a lap portion and a shoulder portion. The lap portion includes a first belt having a belt buckle and a second belt having a belt connector. The first belt is arranged a first side of the seat and the second belt is arranged adjacent a second side of the seat. The belt connector removably couples to the belt buckle. A shoulder portion includes a retractable third belt having a coupling configured to selectively couple to one of the belt buckle and the belt connector. A pretensioner operably coupled to either the first belt or the second belt includes at least one sensor configured to monitor one or more aircraft conditions. Upon detection of a predetermined aircraft condition, the pretensioner applies tension to the first or second belt.

### BACKGROUND OF THE INVENTION

Exemplary embodiments of the invention relate to an aircraft, and more particularly, to a seat restraint intended for use with side facing seats of a fixed wing or rotary wing aircraft.

Passengers seated in side facing seats or seats oriented perpendicular to the direction of flight of an aircraft are typically secured using a known personal restraint system. A conventional personal restraint system, such as a three point seat belt for example, generally includes a seat belt with a tongue slidably connected thereto. The tongue engages a buckle arranged on an opposite side of the seat to define a lap portion and a shoulder portion of the seat belt. The personal restraint system is intended to limit movement of an occupant relative to the seat in the event of a sudden deceleration.

In light of recent crash and injury studies, the Federal Aviation Administration (FAA) has set forth a new policy which enumerates specific injury criteria to be met by the restraint systems used on passengers seated in side-facing seats. Therefore, there is a need to improve the effectiveness of the personal restraint system associated with the side facing seats of an aircraft.

### BRIEF DESCRIPTION OF THE INVENTION

According to one embodiment of the invention, a personal restraint system configured for use with a seat oriented perpendicular to a direction of flight of an aircraft is provided including a lap portion and a shoulder portion. The lap portion includes a first belt having a belt buckle and a second belt having a belt connector. The first belt is arranged a first side of the seat and the second belt is arranged adjacent a second side of the seat. The belt connector removably couples to the belt buckle. A shoulder portion includes a retractable third belt having a coupling configured to selectively couple to one of the belt buckle and the belt connector. A pretensioner operably coupled to one of the first belt and the second belt includes at least one sensor configured to monitor one or more aircraft conditions. Upon detection of a predetermined aircraft condition, the pretensioner applies tension to the first or second belt.

In addition to one or more of the features described above, or as an alternative, in further embodiments the aircraft conditions are defined by an aircraft control module arranged in communication with the at least one sensor.

In addition to one or more of the features described above, or as an alternative, in further embodiments the belt connector is configured to slidably attach to the seat belt.

In addition to one or more of the features described above, or as an alternative, in further embodiments the belt connector is configured to define a lap portion and a shoulder portion of the seat belt when coupled to the belt buckle.

According to another embodiment of the invention, an aircraft is provided including an airframe having one or more seats arranged within the interior of the airframe. The one or more seats are arranged substantially perpendicular to a direction of flight of the aircraft. A personal restraint system is associated with each of the one or more seats arranged substantially perpendicular to the direction of flight. Each personal restraint system includes a lap portion and a shoulder portion. The lap portion includes a first belt having a belt buckle and a second belt having a belt connector. The first belt is arranged a first side of the seat and the second belt is arranged adjacent a second side of the seat. The belt connector removably couples to the belt buckle. A shoulder portion includes a retractable third belt having a coupling configured to selectively couple to one of the belt buckle and the belt connector. A pretensioner operably coupled to one of the first belt and the second belt includes at least one sensor configured to monitor one or more aircraft conditions. Upon detection of a predetermined aircraft condition, the pretensioner applies tension to the first or second belt.

In addition to one or more of the features described above, or as an alternative, in further embodiments the aircraft conditions are defined by an aircraft control module arranged in communication with the at least one sensor.

In addition to one or more of the features described above, or as an alternative, in further embodiments the belt connector is configured to slidably attach to the seat belt.

In addition to one or more of the features described above, or as an alternative, in further embodiments the belt connector is configured to define a lap portion and a shoulder portion of the seat belt when coupled to the belt buckle.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective views of an exemplary rotary wing aircraft embodiment for use with the present invention;

FIG. 2 is a schematic diagram of an interior of a portion of a fuselage of a rotary wing aircraft;

FIG. 3 is a perspective view of a side facing seat including a personal restraint system according to an embodiment of the invention; and

FIG. 4 is a schematic diagram of a pretensioner configured for use with the personal restraint system according to an embodiment of the invention.

The detailed description explains embodiments of the invention, together with advantages and features, by way of example with reference to the drawings.

### DETAILED DESCRIPTION OF THE INVENTION

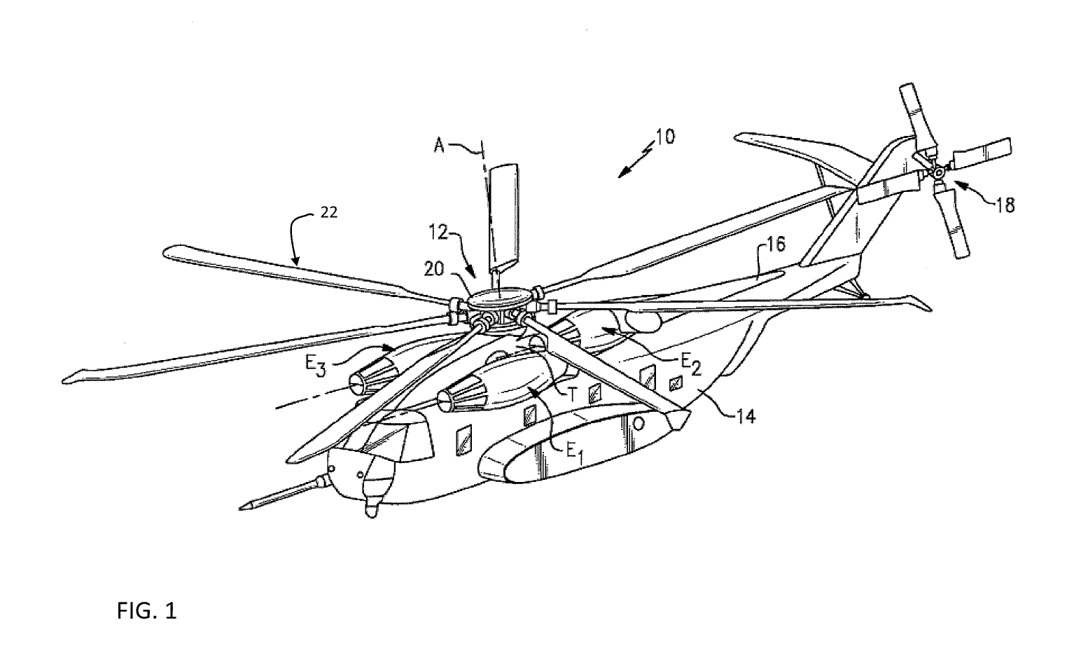

FIG. 1 schematically illustrates a rotary wing aircraft 10 having a main rotor assembly 12. The aircraft 10 includes an airframe 14 having an extending tail 16 which mounts a tail rotor system 18, such as an anti-torque system, a translational thrust system, a pusher propeller, a rotor propulsion system, and the like. The main rotor assembly 12 includes a plurality of rotor blade assemblies 22 mounted to a rotor hub 20. The main rotor assembly 12 is driven about an axis of rotation A through a main gearbox (illustrated schematically at T) by one or more engines E. Although a particular rotary wing aircraft configuration is illustrated and described in the disclosed embodiment, other configurations and/or machines, such as high speed compound rotary wing aircrafts with supplemental translational thrust systems, dual contra-rotating, coaxial rotor system aircrafts, tilt-rotors and tilt-wing aircrafts, and fixed wing aircrafts, will also benefit from embodiments of the invention.

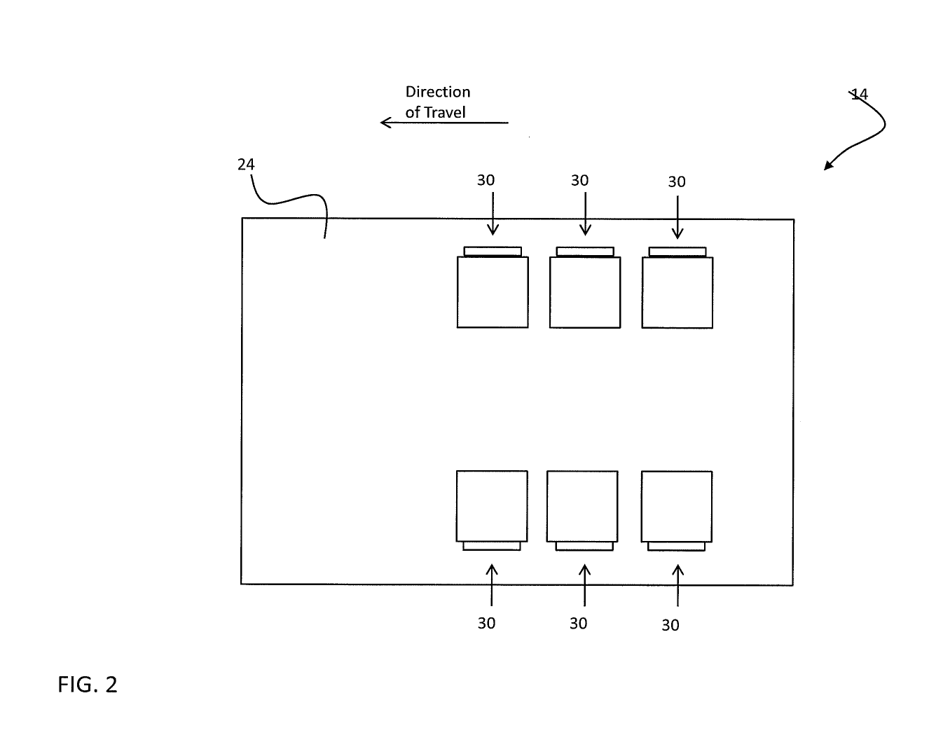

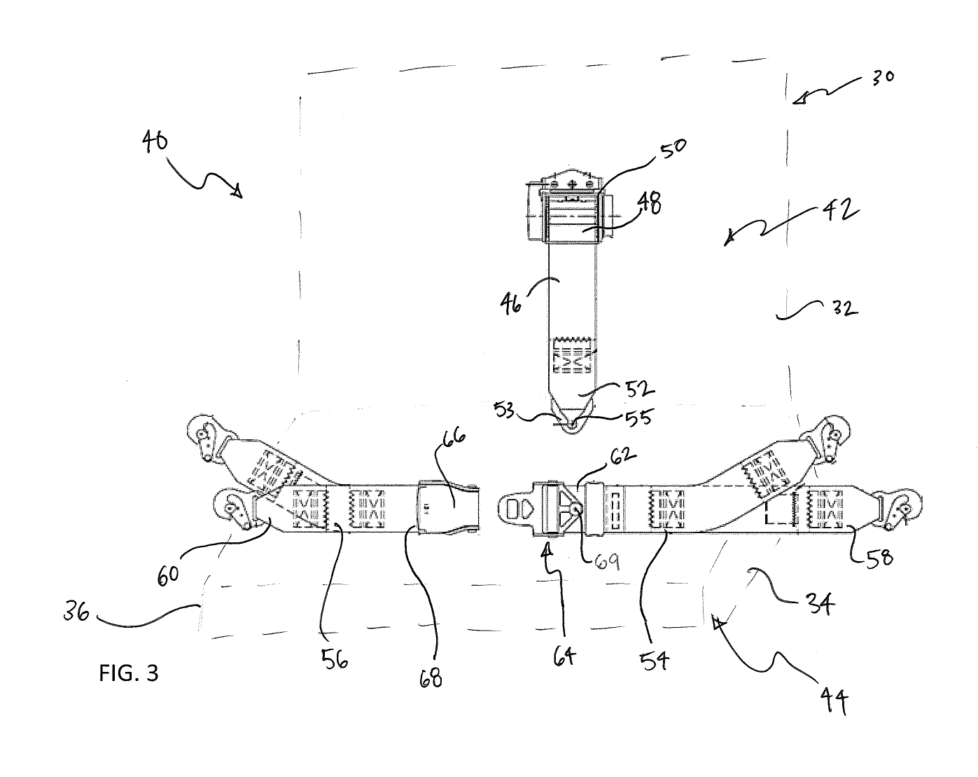

Referring now to FIG. 2, an example of a portion of an interior 24 of the airframe 14 is illustrated. The airframe 14 may include one or more seats for passengers. In the illustrated embodiment, the seats 30 are side facing seats, or seats oriented perpendicular to the direction of flight of the aircraft 10. FIG. 3 is an exploded front view of an example of a personal restraint system 40 configured for use with a side facing seat 30 of a rotary wing aircraft 10. The illustrated, non-limiting personal restraint system 40 includes a selectively connectable shoulder portion 42 and lap portion 44. The shoulder portion 42 includes an elongate and flexible belt or web (conventional seat belt) 46 having a first end 48 wound onto a retractor 50 fixedly attached to a portion of the seat 30 (illustrated schematically in dotted lines), such as the back structure 32 of the seat 30 for example. The retractor 50 may be a conventional retractor having a spring loaded reel or spool that winds the belt into the retractor 50 and maintains tension on the belt 46 when it is buckled around an occupant. A free end 52 of the belt 46 extending from the housing of the retractor 50 includes a coupling 53.

The lap portion 44 of the restraint system 40 includes a first flexible belt 54 and a second flexible belt 56 anchored at a first end 58, 60, respectively, to a portion of the seat 30. In the illustrated, non-limiting embodiment, the first belt 54 is anchored adjacent a first side 34 of the seat 30 and the second belt 56 is anchored adjacent a second opposite side 36 of the seat 30. At least one of the first belt and the second belt is adjustable in length. The free, second end 62 of the first belt 54 includes a belt connector 64 having a tongue configured to releasably engage a buckle 66 attached to the adjacent free, second end 68 of the second belt 56. The buckle 66 can be a conventional seat belt buckle having a button or other actuator for releasing the belt connector 64 when the occupant wishes to depart from the aircraft 10.

The coupling 53 attached to the belt 46 of the shoulder portion 42 connects to one of the belt connector 64 and the buckle 66. In the illustrated, non-limiting embodiment, the belt connector 64 includes a shaped spoke 69 A complementary opening 55 formed in the coupling 53 is configured to slidably receive the spoke 69 extending from the belt connector 64 to lock the shoulder portion 42 of the restraint system 40 to the lap portion 44.

Although a seat occupant is not illustrated in FIG. 3, a person having ordinary skill in the art will understand that the personal restraint system 40 can be used in the conventional manner to restrain an occupant in the side facing seat 30 in the event of a rapid deceleration event, such as an accident for example. To use the personal restraint system 40, a person sits in the seat 30, draws the first and second belts of the lap portion across himself and attaches the belt connector to the buckle. The person then draws the belt of the shoulder portion generally downwardly to attach to the lap portion. The personal restraint system 40 described herein is intended as an example, and other known personal restraint systems, such as systems having a separate shoulder belt and lap belt coupled at the buckle for example, are within the scope of the invention.

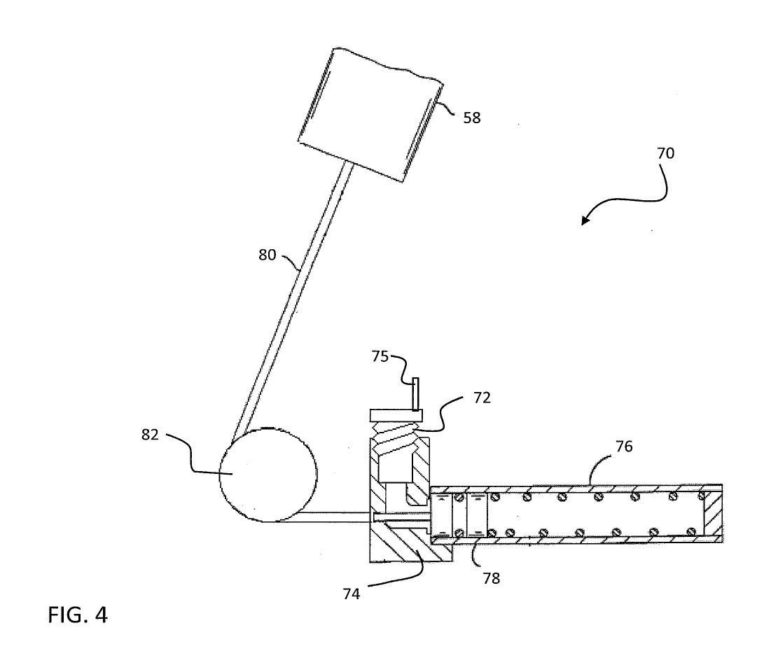

Operably coupled to a portion of the personal restraint system 40, such as the buckle 68 for example, is a pretensioner 70. An example of a pretensioner 70 configured for use with the personal restraint system 40 is illustrated in FIG. 4. In the illustrated, non-limiting embodiment, the pretensioner 70 includes a pyrotechnic cartridge 72 mounted in a housing 74 affixed to a portion of the seat structure 30 or the adjacent airframe 14. The cartridge 72 includes one or more contacts or lead wires 75. A cylinder 76 extending from the housing 74 slidably supports a piston 78. The piston 78 is operably coupled to an anchored end 58, 60 of either the first belt 54 or second belt 56 of the lap portion 44 by a flexible cable 80. In embodiments where the cylinder 76 is positioned in a non-linear arrangement with the anchored ends 58, 60, the cable 80 may be arranged about a pulley 82 positioned between both the belt 54, 56 and the cylinder 76. Although an example of a pyrotechnic pretensioner is illustrated and described herein, other types of pretensioners, such as mechanical or electrical pretensioners for example, are within the scope of the invention.

One or more sensors are configured to sense the occurrence of an aircraft condition, such as a deceleration event, or impact to the aircraft for example. The sensor may be a mechanical sensor having a movable member configured to actuate an electrical circuit. Alternatively, the sensor may be an electronic sensor, such as a piezoelectric transducer or pressure sensor. The sensor may include a controller that determines the existence of such an aircraft condition on the basis of parameters defined by an aircraft control module stored therein.

When a sensor detects the occurrence of a predefined aircraft condition, an electrical signal is supplied to the lead of the pyrotechnic cartridge to explosively generate a relatively high gas pressure. Application of this high gas pressure causes the piston to rapidly slide within the cylinder and exert a pulling force on the cable connected thereto, drawing the belt buckle angularly downward to tension the seat belt.

By including a pretensioner 70 in the personal restraint system 40 of a side facing seat 30 of a rotary wing aircraft 10, the movement of a seat occupant during a crash, collision, or other predefined event is restricted, thereby decreasing the injuries likely to be sustained by the occupant. As a result, the personal restraint system 40 described herein may be adapted to comply with the new FAA regulations. In addition, the pretensioner 70 can be easily added to the pre-existing personal restraint systems 40 without significant modification to the system 40, seat 30, or airframe 14.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A personal restraint system configured for use with a seat oriented perpendicular to a direction of flight of an aircraft, comprising:
a lap portion including:
a first belt having a belt buckle attached thereto, the first belt being arranged adjacent a first side of the seat; and
a second belt having a belt connector attached thereto, the second belt being arranged adjacent a second side of the seat, and the belt connector being configured to removably couple to the belt buckle;
a shoulder portion including a retractable third belt, the third belt including a coupling configured to selectively couple to one of the belt buckle and the belt connector; and
a pretensioner operably coupled to one of the first belt and the second belt, the pretensioner including at least one sensor configured to monitor one or more aircraft conditions, wherein upon detection of a predetermined aircraft condition, the pretensioner is configured to apply tension to the first belt or second belt.

2. The personal restraint system according to claim 1, wherein the aircraft conditions are defined by an aircraft control module arranged in communication with the at least one sensor.

3. The personal restraint system according to claim 1, wherein the belt connector is configured to slidably attach to the belt buckle.

4. The personal restraint system according to claim 1, wherein the first belt and the second belt are positioned adjacent opposing sides of the seat.

5. An aircraft, comprising:
an airframe;
one or more seats arranged within an interior of the airframe, the one or more seats being arranged substantially perpendicular to a direction of flight of the aircraft; and
a personal restraint system associated with each of the one or more seats arranged substantially perpendicular to a direction of flight, each personal restraint system including:
a lap portion including:
a first belt having a belt buckle attached thereto, the first belt being arranged adjacent a first side of the seat; and
a second belt having a belt connector attached thereto, the second belt being arranged adjacent a second side of the seat, and the belt connector being configured to removably couple to the belt buckle;
a shoulder portion including a retractable third belt, the third belt including a coupling configured to selectively couple to one of the belt buckle and the belt connector; and
a pretensioner operably coupled to one of the first belt and the second belt, the pretensioner including at least one sensor configured to monitor one or more aircraft conditions, wherein upon detection of a predetermined aircraft condition, the pretensioner is configured to apply tension to the first belt or second belt.

6. The aircraft according to claim 5, wherein the aircraft conditions are defined by an aircraft control module arranged in communication with the at least one sensor.

7. The aircraft according to claim 5, wherein the belt connector is configured to slidably attach to the belt buckle.

8. The aircraft according to claim 5, wherein the belt buckle and the seat belt are positioned adjacent opposing sides of the seat.
